(19) United States
(12) Patent Application Publication
(10) Pub. No.: US 2026/0116196 A1
(43) Pub. Date: Apr. 30, 2026

(54) ELECTRIC SYSTEM ARCHITECTURE FOR REFUSE VEHICLE

(71) Applicant: Oshkosh Corporation, Oshkosh, WI (US)

(72) Inventor: Brent Radlinger, Oshkosh, WI (US)

(73) Assignee: Oshkosh Corporation, Oshkosh, WI (US)

(21) Appl. No.: 19/369,008

(22) Filed: Oct. 24, 2025

Related U.S. Application Data
(60) Provisional application No. 63/711,912, filed on Oct. 25, 2024.

(51) Int. Cl. B60L 1/00; B65F 3/02; B65F 3/04

(52) U.S. Cl. CPC B60L 1/003; B65F 3/04; B60L 2200/40; B60L 2210/10; B65F 2003/025

(57) ABSTRACT

A refuse vehicle includes a chassis and a body assembly coupled to the chassis. The body assembly includes a storage body. The refuse vehicle also includes a first and second working component, an energy storage device, and a first and second power converter. Each of the first and second working components is coupled or integral to the body assembly and configured to move relative to the storage body. Each of the first and second power converters includes an input electrically connected to the energy storage device. The first power converter is configured to provide a first voltage to the first working component and the second power converter is configured to provide a second voltage to the second working component.

### CROSS-REFERENCE TO RELATED APPLICATIONS

The present application claims the benefit of and priority to U.S. Provisional Patent Application No. 63/711,912, filed on Oct. 25, 2024, the entire contents of which are incorporated by reference herein.

### BACKGROUND

The present application relates generally to the field of refuse vehicles. More specifically, the present application relates to electric refuse vehicles.

### SUMMARY

An exemplary embodiment of the present disclosure relates to a refuse vehicle. The refuse vehicle includes a chassis and a body assembly coupled to the chassis. The body assembly includes a storage body. The refuse vehicle also includes a first working component, a second working component, an energy storage device, a first power converter, and a second power converter. The first working component and the second working component are both coupled or integral to the body assembly and configured to move relative to the storage body. The first power converter and the second power converter both include an input electrically connected to the energy storage device. The first power converter is configured to provide a first voltage to the first working component and the second power converter is configured to provide a second voltage to the second working component.

Another exemplary embodiment of the present disclosure relates to a refuse storage body. The refuse storage body includes a body assembly, a first working component, a second working component, a first power converter, and a second power converter. The body assembly defines a refuse compartment. The first working component is coupled with the body assembly and configured to move relative to the body assembly. The second working component is coupled with the body assembly and configured to move relative to the body assembly. The first power converter is configured to provide a first voltage to the first working component. The first power converter includes a first input electrically coupled to an energy storage device. The second power converter is configured to provide a second voltage to the second working component. The second power converter includes a second input electrically coupled with the energy storage device.

Another exemplary embodiment of the present disclosure relates to a system. The system includes a first power converter and a second power converter. The first power converter is configured to provide a first voltage to a first working component configured to move relative to a refuse storage body. The first power converter includes a first input electrically coupled with an energy storage device. The second power converter is configured to provide a second voltage to a second working component configured to move relative to the refuse storage body. The second power converter includes a second input electrically coupled with the energy storage device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, configured as a front-loading refuse vehicle, according to an exemplary embodiment;

FIG. 2 is another perspective view of a front-loading body assembly that may be used with the refuse vehicle of FIG. 1, according to an exemplary embodiment;

FIG. 3 is a perspective view of a refuse vehicle, configured as a side-loading refuse vehicle, according to an exemplary embodiment;

FIG. 4 is a perspective view of a lift mechanism for use with the side-loading refuse vehicle of FIG. 3, according to an exemplary embodiment;

FIG. 5 is a side sectional view of a refuse vehicle, shown to include a packer assembly, according to an exemplary embodiment;

FIG. 6 is a perspective view of a drive system for a packer assembly that may be used to power movement of the packer assembly of FIG. 5, according to an exemplary embodiment;

FIG. 7 is a block diagram of a control system for a refuse vehicle inclusive of a first power converter and a second power converter, according to an exemplary embodiment;

FIG. 8 is a block diagram of a modular power converter inclusive of multiple converter modules, according to an exemplary embodiment;

FIG. 9 is a block diagram of a control system for a refuse vehicle inclusive of a first modular power converter and a second modular power converter, according to an exemplary embodiment;

FIG. 10 is a perspective view of a thermal management system for use with any of the control systems of FIG. 7-9, according to an exemplary embodiment;

FIG. 11 is a fluid circuit diagram of a thermal management system for an electric system of a refuse vehicle, according to an exemplary embodiment;

FIG. 12 is a front perspective view of an electric system of an electric refuse vehicle, configured as a front-loading refuse vehicle and including a control system, according to an exemplary embodiment; and

FIG. 13 is a front perspective view of an electric system of an electric refuse vehicle, configured as a side-loading refuse vehicle and including a control system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Vocational vehicles are configured to perform specific work-related tasks and are equipped with a variety of working components (i.e., attachments, assemblies, devices, etc.) to aid in performing those tasks. For example, a refuse vehicle, one particular type of vocational vehicle, may be equipped with a lift assembly to aid in depositing refuse into the vehicle, a packing assembly for compacting the refuse contained within the vehicle, an actuatable tailgate to allow ejection of refuse contained within the vehicle, and/or an actuatable top door to provide ingress into the vehicle's storage space, among other working components. In some embodiments, these working components may be electrically actuated (i.e., by means of electric motors, electric actuators, electro-hydraulic actuators, or electro-pneumatic actuators, etc.). However, the diverse and numerous electrical components required to power and control various different working components onboard the vehicle can necessitate different selection and arrangements of components for different vehicle configurations.

Referring generally to the Figures, an electric vocational vehicle (e.g., a refuse vehicle) working component control system (e.g., an electrical system) includes two modular, scalable power converters, co-located in a defined space on the vehicle. By employing modular, scalable power converters, the same control system can be installed on different types of electrically powered vocational vehicles, or differently configured vocational vehicles of the same type (e.g., differently configured refuse vehicles such as a side-load refuse vehicle, a front load refuse vehicle, etc.). Among other benefits, co-locating the first and second power converters can simplify installation and maintenance, reduce the amount and complexity of wiring and electrical connections, and reduce complexity of thermal management for the first and second power converters. Accordingly, the control system disclosed herein provides a simplified, portable control system, in a modular arrangement that may be used across a variety of vocational vehicles.

### Refuse Vehicle

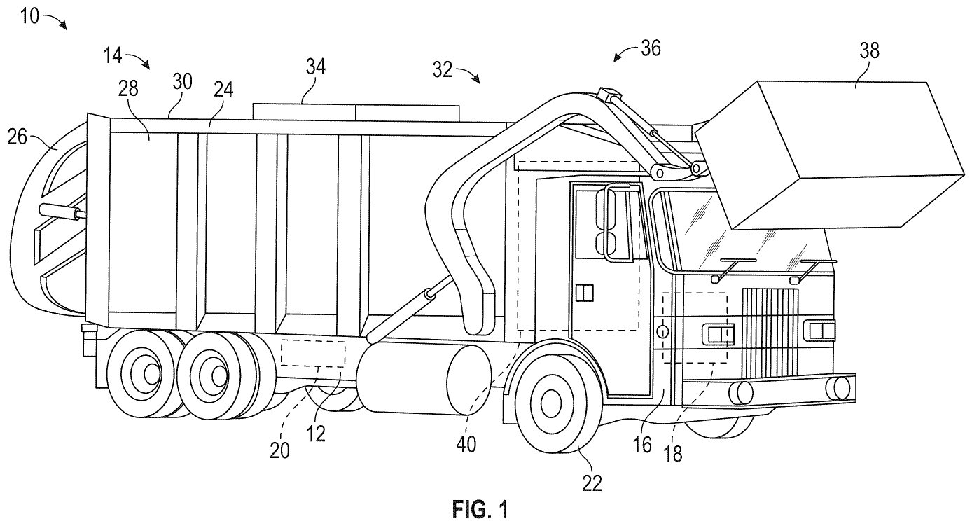

As shown in FIG. 1, a vocational vehicle, shown as refuse vehicle 10 (e.g., a garbage truck, a waste collection truck, a sanitation truck, a recycling truck, etc.), is configured as a front-loading refuse truck. In other embodiments, the refuse vehicle 10 is configured as a side-loading refuse truck or a rear-loading refuse truck. In still other embodiments, the vehicle is another type of vehicle (e.g., a skid-loader, a telehandler, a plow truck, a boom lift, etc.). As shown in FIG. 1, the refuse vehicle 10 includes a chassis, shown as frame 12; a body assembly, shown as body assembly 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.).

As shown in FIG. 1, the refuse vehicle 10 includes a prime mover, shown as electric motor 18, and an energy system, shown as energy storage and/or generation system 20. In other embodiments, the prime mover is or includes an internal combustion engine. According to the exemplary embodiment shown in FIG. 1, the electric motor 18 is coupled to the frame 12 at a position beneath the cab 16. The electric motor 18 is configured to provide power to a plurality of tractive elements, shown as wheels 22 (e.g., via a drive shaft, axles, etc.). In other embodiments, the electric motor 18 is otherwise positioned and/or the refuse vehicle 10 includes a plurality of electric motors to facilitate independently driving one or more of the wheels 22. In still other embodiments, the electric motor 18 or a secondary electric motor is coupled to and configured to drive a hydraulic system that powers hydraulic actuators. According to the exemplary embodiment shown in FIG. 1, the energy storage and/or generation system 20 is coupled to the frame 12 beneath the body assembly 14. In other embodiments, the energy storage and/or generation system 20 is otherwise positioned (e.g., within a tailgate of the refuse vehicle 10, beneath the cab 16, along the top of the body assembly 14, within the body assembly 14, etc.).

According to an exemplary embodiment, the energy storage and/or generation system 20 is configured to (a) receive, generate, and/or store power and (b) provide electric power to (i) the electric motor 18 to drive the wheels 22, (ii) working components of the refuse vehicle 10 to facilitate operation thereof (e.g., a lift assembly, a tailgate, a packer, a grabber, etc.), and/or (iii) other electrically operated accessories of the refuse vehicle 10 (e.g., displays, lights, etc.). The energy storage and/or generation system 20 may include one or more rechargeable batteries (e.g., lithium-ion batteries, nickel-metal hydride batteries, lithium-ion polymer batteries, lead-acid batteries, nickel-cadmium batteries, etc.), capacitors, solar cells, generators, power buses, etc. In one embodiment, the refuse vehicle 10 is a completely electric refuse vehicle. In other embodiments, the refuse vehicle 10 includes an internal combustion generator that utilizes one or more fuels (e.g., gasoline, diesel, propane, natural gas, hydrogen, etc.) to generate electricity to charge the energy storage and/or generation system 20, power the electric motor 18, power the electric actuators, and/or power the other electrically operated accessories (e.g., a hybrid refuse vehicle, etc.). For example, the refuse vehicle 10 may have an internal combustion engine augmented by the electric motor 18 to cooperatively provide power to the wheels 22. The energy storage and/or generation system 20 may thereby be charged via an on-board generator (e.g., an internal combustion generator, a solar panel system, etc.), from an external power source (e.g., overhead power lines, mains power source through a charging input, etc.), and/or via a power regenerative braking system, and provide power to the electrically operated systems of the refuse vehicle 10. In some embodiments, the energy storage and/or generation system 20 includes a heat management system (e.g., liquid cooling, a heat exchanger, air cooling, etc.).

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body assembly 14 includes a storage body, shown as storage body 24, and a tailgate 26 rotatably coupled to the storage body 24. The body assembly 14 may include various actuators (e.g., electric actuators, hydraulic actuators, pneumatic actuators, etc.) to actuate the tailgate 26 relative to the storage body 24. The storage body 24 includes a plurality of panels, shown as panels 28, and a cover 30. The panels 28, the cover 30, and the tailgate 26 define a collection chamber (e.g., hopper, etc.), shown as refuse compartment 32. Loose refuse may be placed into the refuse compartment 32 where it may thereafter be compacted (e.g., by a packer system, etc.). The refuse compartment 32 may provide temporary storage for refuse during transport to a waste disposal site and/or a recycling facility. In some embodiments, at least a portion of the body assembly 14 and the refuse compartment 32 extend above or in front of the cab 16. According to the embodiment shown in FIG. 1, the body assembly 14 and the refuse compartment 32 are positioned behind the cab 16. In some embodiments, the refuse compartment 32 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 32 behind the cab 16 and stored in a position further toward the rear of the refuse compartment 32, a front-loading refuse vehicle, a side-loading refuse vehicle, etc.). In other embodiments, the storage volume is positioned between the hopper volume and the cab 16 (e.g., a rear-loading refuse vehicle, etc.).

As shown in FIG. 1, the refuse vehicle 10 includes a lift mechanism/system (e.g., a front-loading lift assembly, etc.), shown as lift assembly 36, coupled to the front end of the body assembly 14. In other embodiments, the lift assembly 36 extends rearward of the body assembly 14 (e.g., a rear-loading refuse vehicle, etc.). In still other embodiments, the lift assembly 36 extends from a side of the body assembly 14 (e.g., a side-loading refuse vehicle, etc.). As shown in FIG. 1, the lift assembly 36 is configured to engage a container (e.g., a residential trash receptacle, a commercial trash receptacle, a container having a robotic grabber arm, etc.), shown as refuse container 38. The lift assembly 36 may include various actuators (e.g., electric actuators, hydraulic actuators, pneumatic actuators, etc.) to facilitate engaging the refuse container 38, lifting the refuse container 38, and tipping refuse out of the refuse container 38 into the hopper volume of the refuse compartment 32 through an opening in the cover 30 or through the tailgate 26. The lift assembly 36 may thereafter return the empty refuse container 38 to the ground. According to an exemplary embodiment, a door, shown as top door 34, is movably coupled along the cover 30 to seal the opening, thereby preventing refuse from escaping the refuse compartment 32 (e.g., due to wind, bumps in the road, etc.). Various actuators (e.g., electric actuators, hydraulic actuators, pneumatic actuators, etc.) may be included to move the top door 34 relative to the cover 30.

As shown in FIG. 1, the refuse vehicle 10 includes a consolidated vehicle working component control system, shown as control system 40. The control system 40 includes one or more electrical components to convert and/or distribute electrical power from the energy storage and/or generation system 20 to various working components of the refuse vehicle 10 (e.g., the lift assembly 36, the tailgate 26, the top door 34, etc.). In some embodiments, the control system 40 is disposed within the storage body 24. In other embodiments, the control system is otherwise located (e.g., affixed to the frame 12, disposed within the cab 16, etc.).

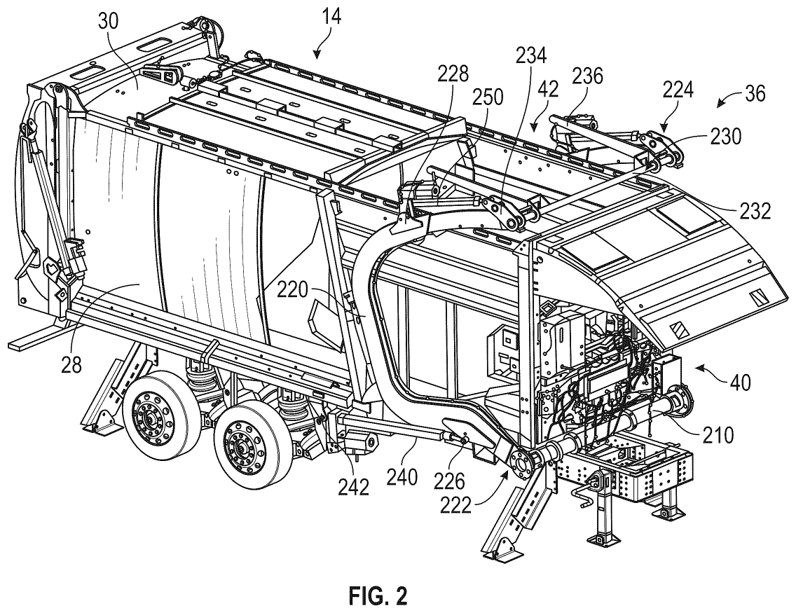

As shown in FIG. 2, the lift assembly 36 is configured as a front-loading lift assembly. According to an exemplary embodiment, the lift assembly 36 is configured to facilitate lifting the refuse container 38 over the cab 16 to dump the contents therein (e.g., trash, recyclables, etc.) into the refuse compartment 32 through an opening, shown as hopper opening 42, in the cover 30 of the body assembly 14. As shown in FIG. 2, the lift assembly 36 includes a rotational coupler, shown as pin 210, extending laterally between the panels 28 of the body assembly 14 at the front end thereof; a pair of lift arms, shown as lift arms 220, having (i) first ends, shown as pin ends 222, pivotally coupled to the body assembly 14 at opposing ends of the pin 210 and (ii) second ends, shown as fork ends 224; and a fork assembly, shown as fork assembly 230, pivotally coupled to the fork ends 224 of the lift arms 220. The fork assembly 230 includes a lateral member, shown as fork shaft 232; a pair of brackets, shown as fork brackets 234, coupled to opposing ends of the fork shaft 232 and coupled to the fork ends 224 of the lift arms; and a pair of forks, shown as forks 236, coupled to opposing ends of the fork shaft 232, inside of the fork brackets 234.

As shown in FIG. 2, each of the lift arms 220 includes a first bracket, shown as lift arm actuator bracket 226, positioned proximate the pin end 222 thereof. As shown in FIG. 2, the body assembly 14 defines an interface, shown as actuator interface 242, on a first lateral side of the body assembly 14. According to an exemplary embodiment, the body assembly 14 defines a similar actuator interface 242 on the opposing lateral side of the body assembly 14. As shown in FIG. 2, the lift assembly 200 includes a pair of first actuators, shown as lift arm actuators 240, extending between the lift arm actuator brackets 226 and the actuator interfaces 242. According to an exemplary embodiment, the lift arm actuators 240 are linear actuators configured to extend and retract to pivot the lift arms 220 and the fork assembly 230 about a lateral axis defined by the pin 210. According to an exemplary embodiment, the lift arm actuators 240 are electric actuators configured to be powered via electricity provided by the energy storage and/or generation system 20 via the control system 40. In one embodiment, the lift arm actuators 240 are or include ball screws driven by an electric motor. In other embodiments, another type of electrically driven, linear actuator is used (e.g., a lead screw actuator, etc.). In an alternative embodiment, the lift arm actuators 240 are hydraulic cylinders driven by an electronically driven hydraulic pump (e.g., driven by the electric motor 18, a secondary electric motor, etc.).

As shown in FIG. 2, each of the lift arms 220 includes a second bracket, shown as fork actuator bracket 228, positioned proximate the fork end 224 thereof. As shown in FIG. 2, the lift assembly 200 includes a pair of second actuators, shown as fork actuators 250, extending between the fork actuator brackets 228 and the fork brackets 234 of the fork assembly 230. According to an exemplary embodiment, the fork actuators 250 are linear actuators configured to extend and retract to pivot the fork assembly 230 (e.g., the forks 236, etc.) relative to the fork ends 224 of the lift arms 220. According to an exemplary embodiment, the fork actuators 250 are electric actuators configured to be powered via electricity provided by the energy storage and/or generation system 20 via the control system 40. In one embodiment, the fork actuators 250 are or include ball screws driven by an electric motor. In other embodiments, another type of electrically driven, linear actuator is used (e.g., a lead screw actuator, etc.). In an alternative embodiment, the fork actuators 250 are hydraulic cylinders driven by an electronically driven hydraulic pump (e.g., driven by the electric motor 18, a secondary electric motor, etc.).

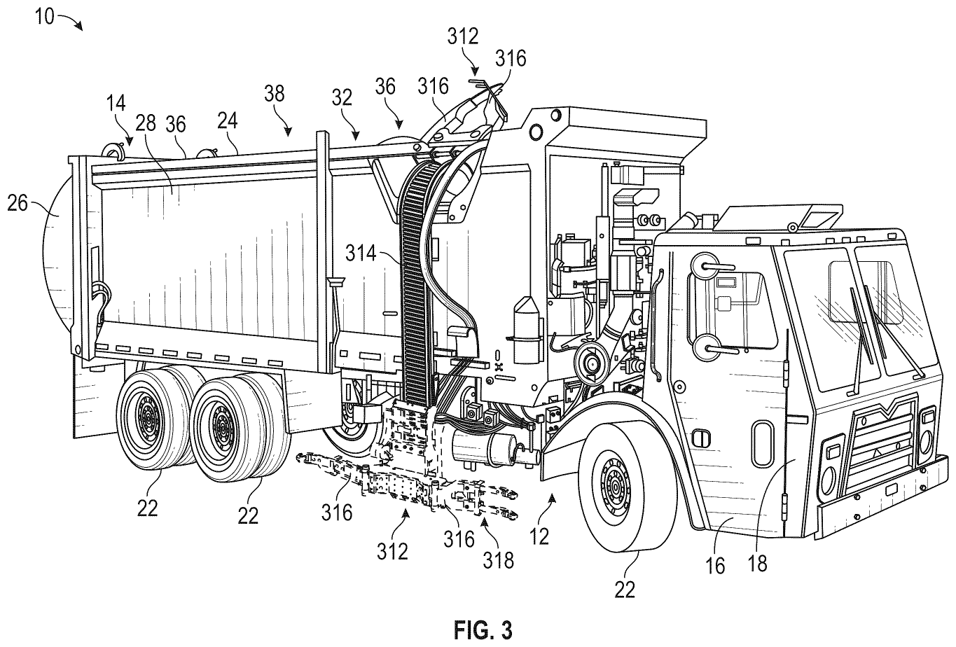

As shown in FIG. 3, refuse vehicle 10 is configured as a side-loading refuse vehicle. The lift assembly 36 includes a grabber assembly, shown as grabber assembly 312, movably coupled to a track, shown as track 314, and configured to move along an entire length of the track 314. According to the exemplary embodiment shown in FIG. 3, the track 314 extends along substantially an entire height of the body assembly 14 and is configured to cause the grabber assembly 312 to tilt near an upper height of the body assembly 14. In other embodiments, the track 314 extends along substantially an entire height of the body assembly 14 on a rear side of the body assembly 14. Refuse vehicle 10 can also include a reach system or assembly coupled with a body or frame of the refuse vehicle 10 and the lift assembly 36. The reach system can include telescoping members, a scissors stack, etc., or any other configuration that can extend or retract to provide additional reach of grabber assembly 312 for refuse collection.

Referring still to FIG. 3, the grabber assembly 312 includes a pair of grabber arms shown as grabber arms 316. The grabber arms 316 are configured to rotate about an axis extending through a bushing. The grabber arms 316 are configured to releasably secure a refuse container to the grabber assembly 312, according to an exemplary embodiment. The grabber arms 316 rotate about the axis extending through the bushing to transition between an engaged state (e.g., a fully grasped configuration, a fully grasped state, a partially grasped configuration, a partially grasped state) and a disengaged state (e.g., a fully open state/configuration, a fully released state/configuration, a partially open state/configuration, a partially released state/configuration). In the engaged state, the grabber arms 316 are rotated towards each other such that the refuse container is grasped therebetween. In the disengaged state, the grabber arms 316 rotate outwards such that the refuse container is not grasped therebetween. By transitioning between the engaged state and the disengaged state, the grabber assembly 312 releasably couples the refuse container with the grabber assembly 312. The refuse vehicle 10 may pull up along-side the refuse container, such that the refuse container is positioned to be grasped by the grabber assembly 312 therebetween. The grabber assembly 312 may then transition into an engaged state to grasp the refuse container. After the refuse container has been securely grasped, the grabber assembly 312 may be transported along the track 314 with the refuse container. When the grabber assembly 312 reaches the end of the track 314, the grabber assembly 312 may tilt and empty the contents of the refuse container into the refuse compartment 32. The tilting is facilitated by the path of the track 314. When the contents of the refuse container have been emptied into the refuse compartment 32, the grabber assembly 312 may descend along the track 314 and return the refuse container to the ground. Once the refuse container has been placed on the ground, the grabber assembly 312 may transition into the disengaged state, releasing the refuse container.

Refuse vehicle 10 can also include a reach assembly 318 that is configured to operate to facilitate extension and retraction of the grabber assembly 312 and/or the lift assembly 36. The reach assembly 318 can be configured to extend or retract from a side (e.g., a lateral side) of refuse vehicle 10 to facilitate lateral reach for the grabber assembly 312 to releasably grasp refuse containers that may be positioned a lateral distance from refuse vehicle 10 (e.g., on a curbside). In some embodiments, the reach assembly 318 is configured to extend or retract to laterally translate the grabber assembly 312 and the lift assembly 36. In some embodiments, the reach assembly 318 is configured to extend or retract to laterally translate the grabber assembly 312 and a portion of lift assembly 36 (e.g., a portion of track 314). The reach assembly 318 can be fixedly coupled, attached, secured, etc., with the frame 12 of refuse vehicle 10 or may be fixedly coupled, attached, secured, etc., with the body assembly 14 of refuse vehicle 10.

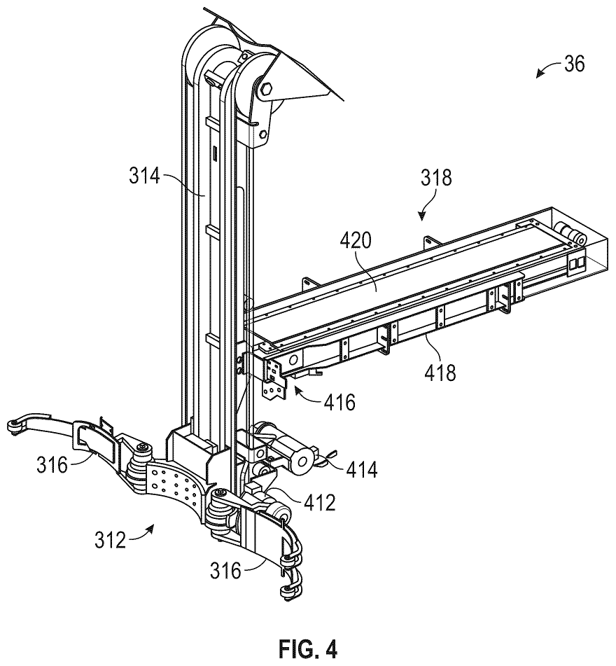

As shown in FIG. 4, the grabber arms 316 of the lift assembly 36 can be driven to grasp and release by an electric motor, shown as grabber motor 412. The grabber assembly 312 can include a gearing system to transfer rotational energy from the grabber motor 412 to the grabber arms 316. In an exemplary embodiment, the rotation of each of the grabber arms 316 is related (e.g., through a gearing system, with connection members, etc.). In other embodiments, the grabber arms 316 are configured to rotate independent of each other. In such embodiments the first of the grabber arms 316 may be driven by a first electric motor, while the second of the grabber arms 316 is driven by a second electric motor.

The grabber assembly 312 can be driven to slidably move along the track 314 by an electric motor, shown as lift motor 414. The lift motor 414 can be fitted with a gear that is configured to engage with a rack affixed along the length of the track 314, therefore functioning as a rack and pinion and transferring rotational energy from the lift motor 414 to the grabber assembly 312. In other embodiments, the lift motor can be fixed to the track 314 and slidably move the grabber assembly 312 along the track by means of a belt or a roller chain.

Still referring to FIG. 4, the reach assembly 318 includes an outer member, shown as outer member 418. The outer member 418 can be fixedly or removably coupled with a body or frame of the refuse vehicle 10. The reach assembly 318 includes a first extendable member, shown as extendable member 420. The extendable member 420 is configured to extend or retract in the longitudinal direction relative to the outer member 418 to facilitate the grabber assembly 312 reaching various refuse containers (e.g., containers that are a distance away from refuse vehicle 10). The extendable member 420 includes a rack, which extends longitudinally along substantially an entire length of the extendable member 420. An electric motor, shown as extension motor 416, is attached to the outer member 418 and is configured to engage the rack extending along the extendable member 420 to extend the extendable member 420 relative to the outer member 418, by means of a gear or gear box fitted to the extension motor 416.

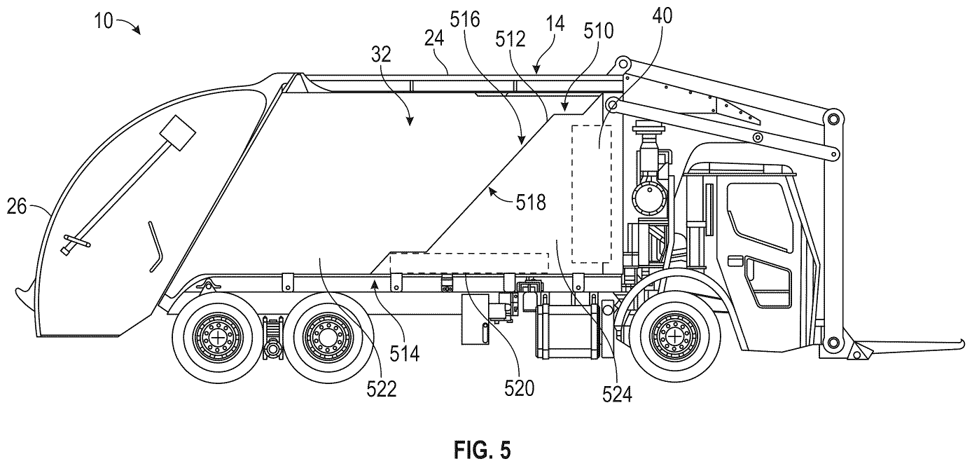

As shown in FIG. 5, the refuse vehicle 10 is equipped with a packer assembly, shown as packer assembly 510. The packer assembly 510 includes a packing plate, shown as packer 512, which is disposed within the refuse compartment 32 of the storage body 24, and is configured to slidably actuate from a receiving position, shown as receiving position 514, towards the rear of the storage body 24. The packer has a substantially planar surface, shown as packing surface 516, for engaging refuse stored within the refuse compartment 32, and a drive surface, shown as drive surface 518, opposite the packing surface 516. A drive mechanism, shown as drive mechanism 520, engages the drive surface 518 to actuate the packer 512. When the tailgate 26 is in a closed position, the packer 512 may be actuated to compact refuse stored within the refuse compartment 32 into a rear portion of the refuse compartment 32. When the tailgate 26 is in an opened position, the packer 512 may be actuated to eject refuse stored within the refuse compartment 32 out of the refuse compartment 32. Accordingly, the packer assembly 510 may be used to (a) compact stored refuse to provide additional room or space within the refuse compartment 32 for additional refuse and (b) eject stored refuse from within the refuse compartment 32.

When in the receiving position 514, the packer 512 divides the refuse compartment 32 into a storage space, shown as refuse storage space 522, and a forward space, shown as forward space 524, forward of the storage space 522. In some embodiments, the control system 40 of the refuse vehicle 10 is located within the forward space 524. Locating the control system 40 in the forward space 524, promotes easy installation and maintenance of the control system 40 where the control system 40 may be accessed, for example, from an area adjacent the forward end of the body assembly 14 (e.g., without removal of body assembly components, etc.).

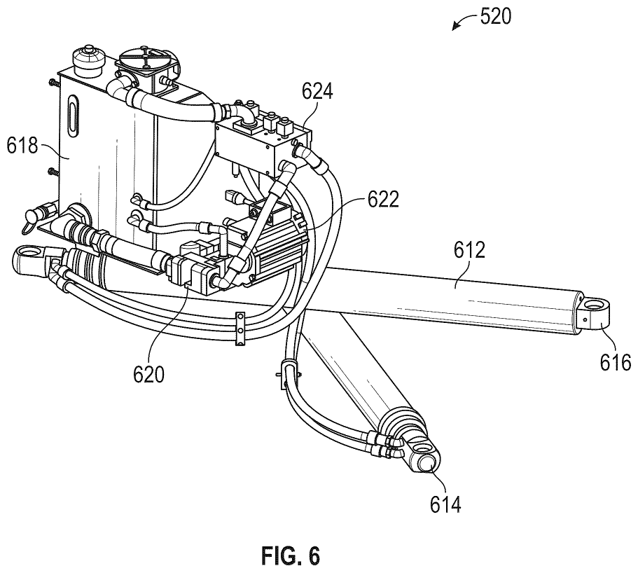

As shown in FIG. 6, the drive mechanism 520 may include a pair of actuators, shown as packer actuators 612, configured to move the packer 512 from the receiving position 514 towards the rear of the refuse compartment 32. In an exemplary embodiment, the packer actuators 612 are linear actuators, each having a body end, shown as body end 614, and a packer end, shown as packer end 616. The body end 614 is pivotably coupled to the body assembly 14 and the packer end 616 is pivotably coupled to the drive surface 518 of the packer 512. In this configuration, when the packer actuators 612 extend, the packer 512 slidably moves from the receiving position 514 towards the rear of the refuse compartment 32, and when the packer actuators 612 retract, the packer 512 slidably moves from a position towards the rear of the refuse compartment 32 back to the receiving position 514. In one embodiment, the packer actuators 612 are electric actuators configured to be powered via electricity provided by the energy storage and/or generation system 20 via the control system 40. In another embodiment, the packer actuators 612 are or include ball screws driven by an electric motor. In still other embodiments, another type of electrically driven, linear actuator is used (e.g., a lead screw actuator, etc.).

According to an exemplary embodiment, the packer actuators 612 are hydraulic cylinders. In such an embodiment, the drive mechanism 520 of the packer assembly 510 includes a hydraulic fluid reservoir, shown as hydraulic reservoir 618, fluidly coupled to a pump, shown as hydraulic pump 620. The hydraulic pump 620 is driven by an electric pump motor, shown as pump motor 622. The pump motor 622 may be configured to be powered by the energy storage and/or generation system 20 via the control system 40 of the refuse vehicle 10. The hydraulic pump 620 is fluidly coupled to a control valve, shown as directional control valve 624, which is in turn, fluidly coupled to the packer actuators 612. When driven by the pump motor 622, the hydraulic pump 620 pressurizes a volume of hydraulic fluid, which is selectively released into the packer actuators 612, by the directional control valve 624, in a manner to either extend or retract the packer actuators 612. The directional control valve 624 may be electronically controlled (e.g., by the control system 40, or a component thereof).

### Control System

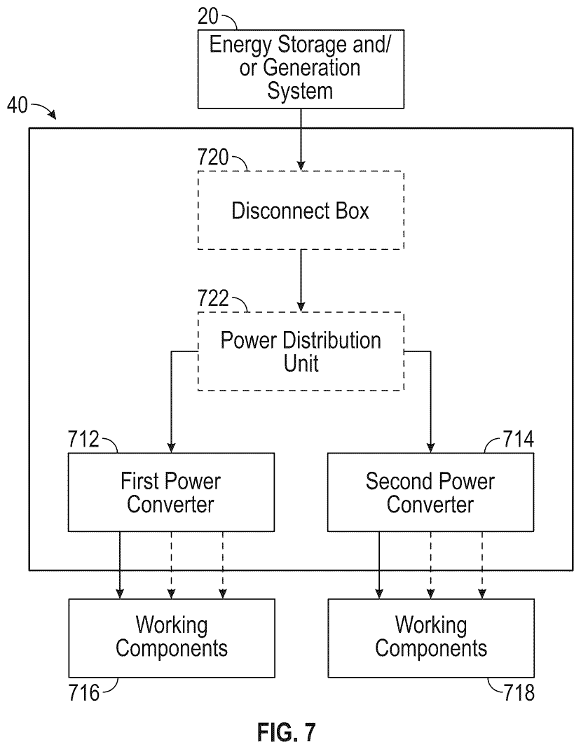

As shown in FIG. 7, the control system 40 is configured to receive electrical energy from the energy storage and/or generation system 20, or another electrical energy source (e.g., a secondary battery, generator, solar panels, etc.), and to provide electrical energy and control signals to one or more working components (e.g., lift assembly 36, tailgate 26, packer assembly 510, etc.) or a subset of electrical components constituting a working component (e.g., an actuator, a motor, etc.).

In an exemplary embodiment, control system 40 includes a first power converter, shown as first power converter 712, and a second power converter, shown as second power converter 714. The first power converter 712 and the second power converter 714 are each electrically coupled to the energy storage and/or generation system 20 and receive an input voltage from the energy storage and/or generation system 20. The first power converter 712 is configured to provide one or more output voltages that differ from the input voltage (e.g., is/are of a different amplitude, frequency, or form) to a first working component, set of working components, or a subset of electrical components constituting a single working component, shown as first set of working components 716. The second power converter 714 is configured to provide one or more output voltages that differ from the input voltage (e.g., is/are of a different amplitude, frequency, or form) to a second working component, set of working components, or subset of electrical components constituting a single working component, shown as second set of working components 718.

In an exemplary embodiment, the control system 40 may include an electrical disconnect device, shown as disconnect box 720, between the energy storage and/or generation system 20 and the first and second power converters 712 and 714. The disconnect box 720 may be actuatable to selectively electrically decouple the first and second power converters 712 and 714 from the energy storage and/or generation system 20, thus also selectively de-energizing the first set of working components 716 and the second set of working components 718, which are energized by the first power converter 712 and the second power converter 714, respectively. In some embodiments, the disconnect box 720 may include an electrical switch (e.g., a toggle switch, push-button switch, rotary selector, etc.) to manually couple or decouple the control system 40 from the energy storage and/or generation system 20. In other embodiments, the disconnect box may include a circuit protection device (e.g., a circuit breaker, fuse, thermal cutoff, etc.) to automatically couple or decouple the control system 40 from the energy storage and/or generation system 20 when one or more environmental or working conditions are met. In still other embodiments, the disconnect box 720 may include an electrically operated switch (e.g., a relay, contactor, etc.) to electrically couple or decouple the control system 40 from the energy storage and/or generation system 20.

According to an exemplary embodiment, the control system 40 may include a power distribution unit, shown as power distribution unit 722, between the energy storage and/or generation system 20 and the first and second power converters 712 and 714. The power distribution unit 722 provides electrical communication between a single input, here, the energy storage and/or generation system 20, and multiple outputs, here, the first power converter 712 and the second power converter 714. The power distribution unit 722 may achieve electrical communication between the energy storage and/or generation system 20 and the first and second power converters 712 and 714 by means of wire, cables, bus bars, terminal strips, or other electrically conductive elements. The power distribution unit 722 may also include one or more electrical components (e.g., a switch, relay, circuit breaker, etc.) to selectively couple or decouple one of the first or second power converters 712 or 714 from the energy storage and/or generation system 20.

The working components constituting the first set of working components 716 and the second set of working components 718, may be selected and divided between the first set of working components 716 and the second set of working components 718 so as to simplify wiring on the refuse vehicle 10 (e.g., by reducing cable lengths, by simplifying cable management requirements, by reducing the number of high voltage connections, etc.). It should be noted that in other embodiments, the control system 40 may include additional power converters configured to provide one or more voltages to additional working components, sets of working components, or subsets of electrical components constituting a single working component.

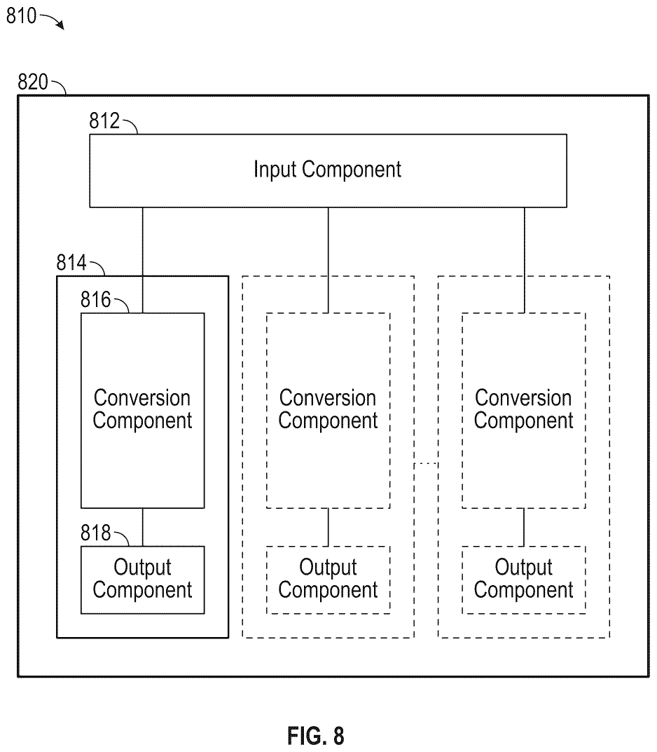

As shown in FIG. 8, in some embodiments, the first power converter 712 and/or the second power converter 714 may be a modular power converter, shown as modular power converter 810. As shown in FIG. 8, the modular power converter 810 includes an input component, an input interface, etc., shown as input component 812, and one or more (e.g., one, two, three, four, etc.) converter modules, shown as converter module 814. In an exemplary embodiment, the input component 812 and each of the one or more converter modules 814 are contained within a single chassis, shown as power converter chassis 820. In some embodiments, the one or more converter modules 814 can be manually and independently removed from or inserted into the power converter chassis 820.

The input component 812 may include an input terminal or terminals (e.g., one or more terminal blocks, connectors, wires, cables, etc.) configured to receive an input voltage (e.g., from the energy storage and/or generation system 20). In some embodiments, the input component 812 further includes a filtering circuit comprising one or more electrical components (e.g., capacitors, inductors, resistors, etc.) to reduce input voltage ripple and to filter out noise. The input component 812 is electrically connected to, and configured to provide the input voltage to, each of the one or more converter modules 814.

Each of the one or more converter modules 814 may include a conversion component, shown as conversion component 816, and an output, shown as output component 818. The conversion component 816 may include at least one electrical component (e.g., a transformer, inverter, DC-to-DC converter, rectifier, etc.) configured to convert the input voltage to an output voltage differing from the input voltage (e.g., a voltage of a different amplitude, frequency, form, etc.). The output component 818 may include an output terminal or terminals (e.g., one or more terminal block, connector, wire, cable, etc.) configured to provide the output voltage (e.g., to a working component of the refuse vehicle 10). In some embodiments, the output component 818 further includes a filtering circuit comprising one or more electrical components (e.g., capacitors, inductors, resistors, etc.) to reduce output voltage ripple and to filter out noise.

In some embodiments, where the modular power converter 810 is equipped with multiple converter modules 814, the multiple converter modules 814 may be differently configured to provide different output voltages at each output component 818. For example, where the input component 812 of the modular power converter 810 is connected to a battery or some other DC voltage source, one or more of the converter modules 814 may have a conversion component 816 including an electrical inverter to provide an AC voltage at the corresponding output component 818, and one or more of the converter modules 814 may have a conversion component 816 including a DC-to-DC converter to provide a DC voltage at the corresponding output component 818 that differs in amplitude from that provided by the battery or other DC voltage source. Similarly, where the input component of the modular power converter 810 is connected to an AC voltage source, one or more of the converter modules 814 may have a conversion component 816 including a rectifier to provide a DC voltage at the corresponding output component 818, and one or more of the converter modules 814 may have a conversion component 816 including a transformer to provide an AC voltage at the corresponding output component 818 that differs in amplitude from that provided by the AC voltage source.

In some embodiments, where the modular power converter 810 is equipped with multiple converter modules 814, the multiple converter modules 814 may be similarly configured to provide similar output voltages at each output component 818 of each converter module 814. For example, where the input component 812 of the modular power converter 810 is connected to a battery, or some other DC voltage source, each of the one or more of the converter modules 814 may have a conversion component 816 including an electrical inverter to provide an AC voltage at each corresponding output component 818. Similarly, where the input component of the modular power converter 810 is connected to an AC voltage source, each of the one or more of the converter modules 814 may have a conversion component 816 including a rectifier to provide a DC voltage at each corresponding output component 818.

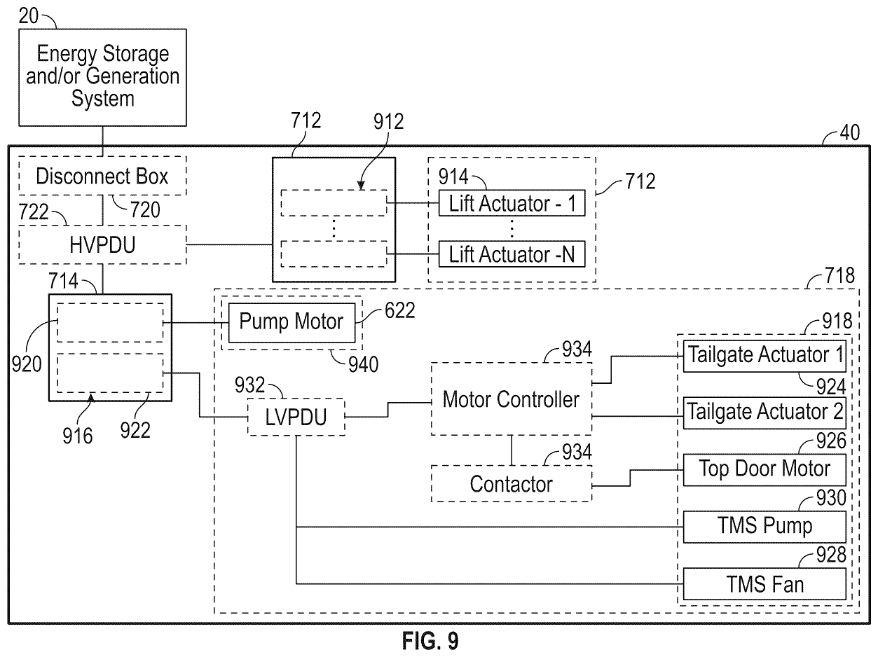

As shown in FIG. 9, in an exemplary embodiment, the first and second power converters 712 and 714 of control system 40 are modular power converters 810. The first power converter 712 and the second power converter 714 are electrically coupled to the energy storage and/or generation system 20 to receive an input voltage therefrom. In some embodiments, the energy storage and/or generation system 20 is a battery having a voltage of between 550 and 750 volts DC. In some embodiments, an electrical disconnect device, such as disconnect box 720, is positioned between the energy storage and/or generation system 20 and the first and second power converters 712 and 714, so that the control system 40 may be decoupled from the energy storage and/or generation system 20 and deenergized to allow for safe maintenance and/or installation. In some embodiments, a power distribution unit, such as power distribution unit 722 is located between the energy storage and/or generation system 20 and the first and second power converters 712 and 714 to provide electrical communication between the energy storage and/or generation system 20 and the first and second power converters 712 and 714.

In an exemplary embodiment, the first power converter 712 includes a plurality of converter modules 912 to provide a plurality of output voltages to the first set of working components 716. In some embodiments, the first set of working components 716 includes a lift assembly 36 having a plurality of actuators 914. In such embodiments, each of the plurality of converter modules 912 of the first power converter 712 include an inverter to provide an AC voltage to one of a plurality of actuators 914 of the lift assembly 36. For example, where the lift assembly 36 is configured as a front-loading lift assembly, as shown in FIG. 2, the first power converter 712 may be configured to include four converter modules 912, each including an electrical inverter, the first configured to provide a voltage to one of the two lift arm actuators 240, the second configured to provide a voltage to the other of the two lift arm actuators 240, the third configured to provide a voltage to one of the two fork actuators 250, and the fourth configured to provide a voltage to the other of the two fork actuators 250. In another example, where the lift assembly 36 is configured as a side-loading lift assembly, as shown in FIG. 3, the first power converter 712 may include three converter modules 912, each including an electrical inverter, the first configured to provide a voltage to the extension motor 416, the second configured to provide a voltage to the lift motor 414, and the third configured to provide a voltage to the grabber motor 412.

Still referring to FIG. 9, in an exemplary embodiment, the second power converter 714 includes one or more converter modules 916 to provide one or more output voltages to the second set of working components 718. In an exemplary embodiment, the second set of working components 718 may include a first subset of working components requiring a high voltage AC voltage, shown as high voltage subset of working components 940, and/or a second subset of components requiring a low voltage DC voltage, shown as low voltage subset of working components 918. In such an embodiment, the one or more converter modules 916 includes a first converter module including an electric inverter, shown as inverter module 920, configured to provide an AC voltage to the high voltage subset of working components 940. The one or more converter modules 916 may include a second converter module including a DC-to-DC converter, shown as DC converter module 922, configured to provide a low voltage DC voltage (e.g., 6 VDC, 12 VDC, 18 VDC, 24 VDC, 30 VDC, 36 VDC, 42 VDC, 48 VDC, 54 VDC, 60 VDC, etc.) to the low voltage subset of working components 918. The voltage provided by the inverter module 920 may be greater than the voltage provided by the DC converter module 922.

In an exemplary embodiment, the high voltage subset of working components 940 includes the packer assembly 510 having a hydraulic pump motor 622, and the low voltage subset of components includes the tailgate 26 having a pair of actuators, shown as tailgate actuators 924, a top door 34 having a top door motor, shown as top door motor 926, a thermal management system having a coolant pump, shown as TMS pump 928, and a fan, shown as TMS fan 930.

In some embodiments, the control system 40 includes a second power distribution device, shown as low voltage power distribution unit 932, positioned between the DC converter module 922 and the low voltage subset of working components 918. The low voltage power distribution unit 932 provides electrical communication between a single input, here, the DC converter module 922, and multiple outputs, here, one or more of the components constituting the low voltage subset of working components 918. The low voltage power distribution unit 932 may achieve electrical communication between the DC converter module 922 and one or more of the components comprising the low voltage subset of working components 918 by means of wire, cables, bus bars, terminal strips, or other electrically conductive elements. The low voltage power distribution unit 932 may also include one or more electrical components (e.g., a switch, relay, circuit breaker, etc.) to selectively decouple a single component of the low voltage subset of working components 918 from the DC converter module 922.

In an exemplary embodiment, the control system 40 includes a motor controller, shown as motor controller 934. The motor controller 934 is configured to receive an input voltage from the DC converter module 922 of the second power converter 714 and to provide a variable output voltage to one or more components, based on one or more control signals, to achieve a desired behavior of the components. In some embodiments, the motor controller 934, is configured to control the tailgate actuators 924 so as to open and close the tailgate in response to an operator command and/or a position sensor associated with the tailgate actuators 924.

In an exemplary embodiment, the control system includes a contactor 936. The contactor 936 is used to selectively provide the voltage provided by the DC converter module 922 of the second power converter 714 to one or more components. In some embodiments, the contactor 936 is controlled by the motor controller 934 to selectively engage the top door motor 926. In some embodiments, the contactor 936 is a multipolar contactor. In an exemplary embodiment, contactor 936 is controlled by the motor controller 934 to reversibly operate the top door motor 926 to open or close the top door.

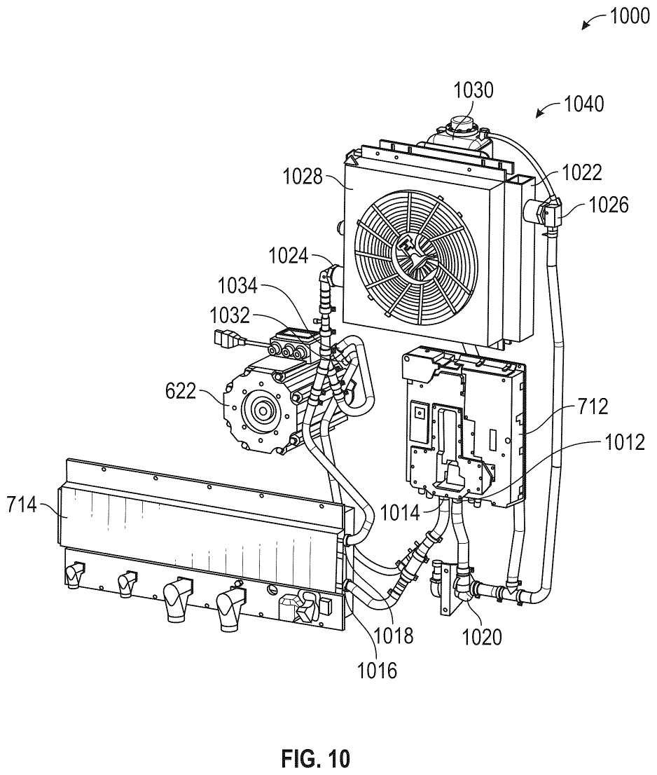

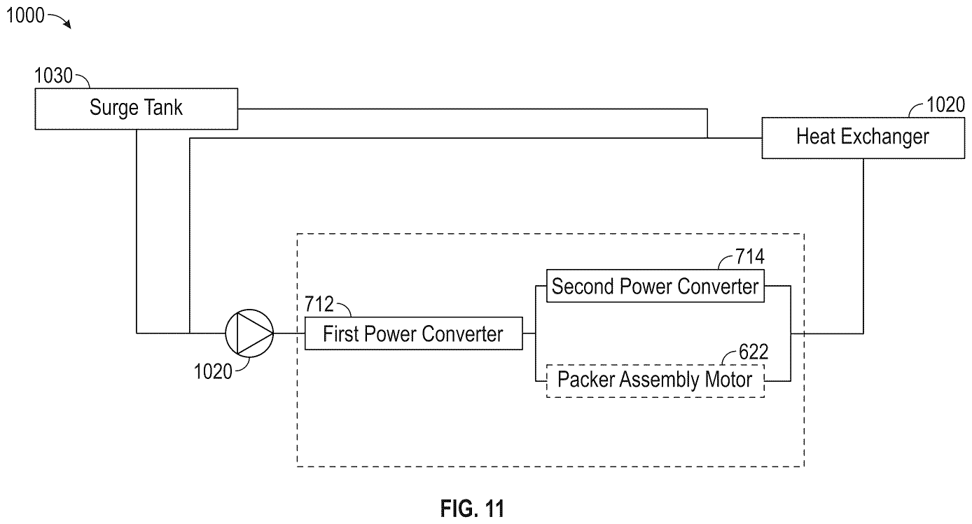

As shown in FIGS. 10 and 11, in an exemplary embodiment, the control system 40 has a thermal management system 1000. In such an embodiment, the first power converter 712 has a cooling component, thermally coupled to the heat producing components of the first power converter 712, and having an inlet, shown as first power converter coolant inlet 1012, and an outlet, shown as first power converter coolant outlet 1014. The second power converter 714, similarly, has a cooling component, thermally coupled to the heat producing components of the second power converter 714, and having an inlet, shown as second power converter coolant inlet 1016, and an outlet, shown as second power converter outlet 1018.

The thermal management system 1000 has a pump, shown as coolant pump 1020. The coolant pump may be a mechanical, impeller type, fluid pump. In some embodiments, the coolant pump is driven by an electric motor. The thermal management system 1000 also includes a heat exchanger, shown as heat exchanger 1040. The heat exchanger 1040 includes a radiator, shown as radiator 1022. The radiator 1022 has an inlet, shown as radiator inlet 1024, fluidly coupled to an outlet, shown as radiator outlet 1026, through an arrangement of tubes configured to provide maximal surface contact between the tubes and the fluid flowing therein. The arrangement of tubes connecting the radiator inlet 1024 to the radiator outlet 1026 may be affixed, on their outer surface, to an arrangement of fins to conduct thermal energy from the tubes to the ambient air. In some embodiments, the heat exchanger 1040 includes a fan, shown as radiator fan 1028, mounted, or located proximate, to the radiator 1022 such that, when operative, the radiator fan 1028 forces ambient air across the arrangement of tubes and fins coupling the radiator inlet 1024 and the radiator outlet 1026.

In an exemplary embodiment, the output of the coolant pump 1020 is connected to the first power converter coolant inlet 1012, the first power converter coolant outlet 1014 is connected to the second power converter coolant inlet 1016, the second power converter outlet 1018 is connected to the radiator inlet 1024, and the radiator outlet 1026 is connected to the input of the coolant pump 1020. In such an embodiment, the coolant pump 1020, when operative, forces a liquid coolant through the first power converter 712 and the second power converter 714, sequentially, where it is heated, then through the heat exchanger 1040, where it is cooled before returning to the coolant pump 1020. In another embodiment, the output of the coolant pump 1020 is connected to the first power converter coolant inlet 1012 and the second power converter coolant inlet 1016, the first power converter coolant outlet 1014 and the second power converter outlet 1018 are connected to the radiator inlet 1024, and the radiator outlet 1026 is connected to the input of the coolant pump 1020. In such an embodiment, the coolant pump 1020, when operative, forces a liquid coolant through the first power converter 712 and the second power converter 714, simultaneously, where it is heated, then through the heat exchanger 1040, where it is cooled before returning to the coolant pump 1020.

In some embodiments, the thermal management system 1000 can be configured to cool components other than those comprising the control system 40. In an exemplary embodiment, the thermal management system 1000 of the control system 40 is configured to cool the pump motor 622 of the packer assembly 510. In such embodiments, the pump motor 622 has a coolant inlet, shown as hydraulic motor coolant inlet 1032, and a coolant outlet, shown as hydraulic motor coolant outlet 1034. In an exemplary embodiment, the output of the coolant pump 1020 is connected to the first power converter coolant inlet 1012, the first power converter coolant outlet 1014 is connected to the second power converter coolant inlet 1016 and the hydraulic motor coolant inlet 1032, the second power converter outlet 1018 and the hydraulic motor coolant outlet 1034 are connected to the radiator inlet 1024, and the radiator outlet 1026 is connected to the input of the coolant pump 1020. In such an embodiment, the coolant pump 1020, when operative, forces a liquid coolant through the first power converter 712, then through the second power converter 714 and the pump motor 622, simultaneously, where it is heated, then through the heat exchanger 1040, where it is cooled before returning to the coolant pump 1020.

In an exemplary embodiment, the thermal management system 1000 includes an overflow tank, shown as surge tank 1030. The inlet of the surge tank 1030 is connected to the radiator outlet 1026 and the outlet of the surge tank 1030 is connected to the input of the coolant pump 1020. Under certain conditions, such as when the volume of coolant within the coolant circuit expands due to heating, or when a restriction within the coolant circuit interrupts coolant flow, the surge tank provides a storage volume for excess coolant.

In some embodiments, the radiator fan 1028 and an electric motor driving the coolant pump 1020 are powered by the first power converter 712 or the second power converter 714. In some embodiments, the thermal management system includes a temperature sensor to selectively operate the radiator fan 1028 and/or the electric motor driving the coolant pump 1020.

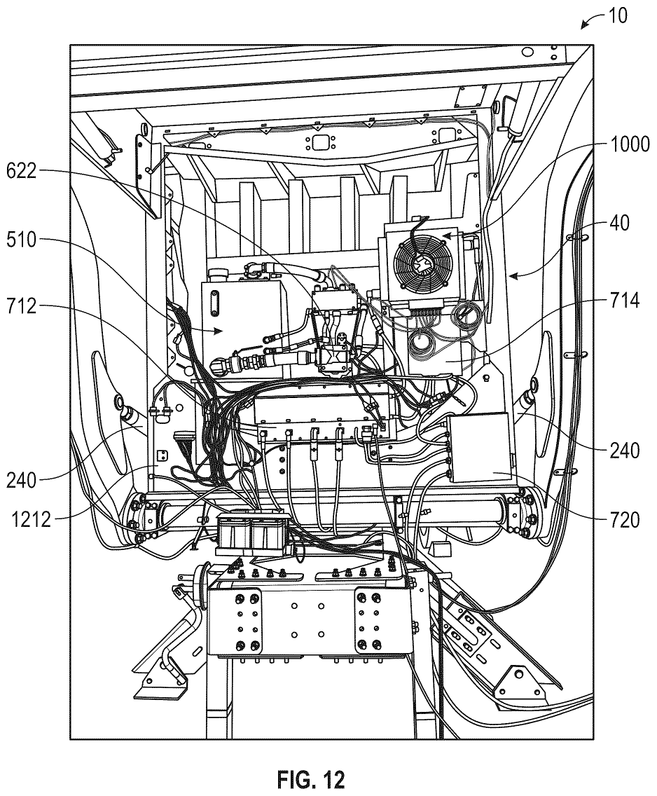

As shown in FIG. 12, the refuse vehicle 10 is configured as a front-loading refuse vehicle with a packer assembly 510. The components comprising the control system 40 are co-located within the forward space 524 of the refuse compartment 32. The disconnect box 720 is connected to the energy storage and/or generation system 20 and provides a voltage therefrom to the first power converter 712 and the second power converter 714. The first power converter 712 includes four inverter converter modules to provide an AC voltage to each actuator of the pair of lift arm actuators 240 and fork actuators 250 of the lift assembly 36. The second power converter 714 includes an inverter converter module and a DC-to-DC converter module. The inverter converter module provides an AC voltage to the drive mechanism 520 of the packer assembly 510. In an exemplary embodiment, the drive mechanism 520 of the packer assembly 510 is the electro-hydraulic drive mechanism 520 shown in FIG. 6. The DC-to-DC converter module provides a voltage to one or more low voltage working components (e.g., the tailgate 26, the top door 34, or the thermal management system 1000, etc.).

Still referring to FIG. 12, the thermal management system 1000 of the control system 40 is configured to cool the first power converter 712, the second power converter 714, and the hydraulic pump motor 622 of the packer assembly's drive mechanism 520. The thermal management system 1000 is configured to force a coolant first through the second power converter 714, then parallelly through the first power converter 712 and the hydraulic pump motor 622, before cooling and recycling the coolant through the coolant circuit.

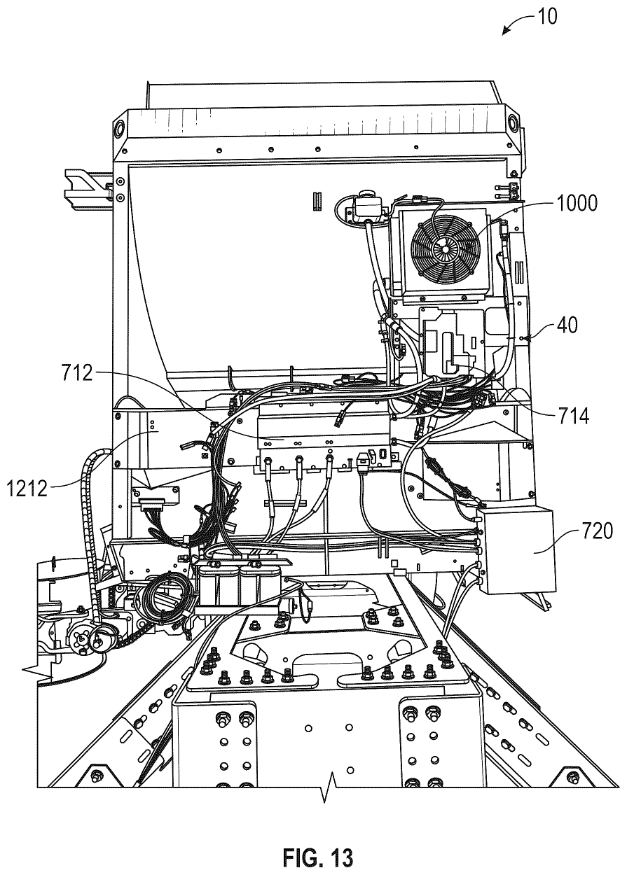

As shown in FIG. 13, the refuse vehicle 10 is configured as a side-loading refuse vehicle. The refuse vehicle 10 does not include a packer assembly 510. The components comprising the control system 40 of the refuse vehicle 10 are co-located in a space forward of the refuse compartment 32. The disconnect box 720 is connected to the energy storage and/or generation system 20 and provides a voltage therefrom to the first power converter 712 and the second power converter 714. The first power converter 712 includes three inverter converter modules to provide an AC voltage to each of the lift motor 414, grabber motor 412, and extension motor 416 of the lift assembly 36. The second power converter 714 includes a DC-to-DC converter module. The DC-to-DC converter module provides a voltage to one or more low voltage working components (e.g., the tailgate 26, the top door 34, or the thermal management system 1000, etc.).

Still referring to FIG. 13, the thermal management system 1000 of the control system 40 is configured to cool the first power converter 712 and the second power converter 714. The thermal management system 1000 is configured to force a coolant first through the second power converter 714, then through the first power converter 712, before cooling and recycling the coolant through the coolant circuit.

In an exemplary embodiment, and as shown in FIGS. 12 and 13, a support structure 1212 is configured to removably couple the various components of the control system 40 (e.g., the first power converter 712, the second power converter 714, the disconnect box 720, the power distribution unit 722, etc.) to the body assembly 14. The removable coupling of the various components of the control system 40 to the body assembly 14 allows access, maintenance, repair, or removal of one or more components of the control system 40 without necessitating the removal or disturbance of other components of the control system 40. The support structure 1212 may include one or more mounting plates, brackets, frames, enclosures, or other suitable fixtures to provide stable positioning and mechanical support, while facilitating quick-release or tool assisted removal of individual components of the control system 40.

In some embodiments, the support structure 1212 is positioned in the forward space 524 of the body assembly 14 so that the various components of the control system 40 are accessible from outside of the body assembly 14 (e.g., from a front side of the body assembly 14 between the body assembly 14 and the cab 16). The body assembly 14 may include a movable or removable access panel, door, or cover to enclose the forward space 524 of the body assembly 14 and to provide environmental protection to the control system 40 (e.g., to prevent water, refuse, dirt, etc., from entering the forward space 524). In some embodiments, the support structure 1212 includes integrated cable management channels to ensure precise positioning, mitigate mechanical stresses, and maintain organized routing of electrical conductors associated with the control system 40.

### Configuration of Exemplary Embodiments

It should be noted that any of the electric motors, electric linear actuators, etc., can include a brake that can lock or facilitate restricting rotational output from an output driveshaft of any of the electric motors. For example, any of the electric motors can include a drum brake configured to activate and provide a frictional force to the electric motor driveshaft to facilitate preventing rotation of the driveshaft thereof. The brake can be activated using mechanical systems, or an electrical system. For example, the brake may be an electrically activated drum brake, a mechanical brake, an electrical brake, etc. The brake can be configured to decrease output speed of the driveshaft of the electric motor or to facilitate locking a current angular position of the driveshaft of the electric motor. The brake can be operated by the same controller or control system that operates the electric motors and electric linear actuators, or can be operated by a separate control system and/or a separate controller. Additionally, any of the electric motors or linear electric actuators described herein can include appropriate gearboxes to increase or decrease output torque.

It should also be noted that any of the electrical motors, electrical actuators, or any other electrical movers can include any number of sensors configured to measure and monitor an angular position or a degree of extension. In some embodiments, the sensors are a component of the electric motors or the electric linear actuators and provide feedback signals to a controller. The controller can monitor the sensor signals to identify an angular position or a degree of extension of the electric motors or the electric linear actuators, respectively.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.w23It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body assembly coupled to the chassis, the body assembly comprising a storage body;
a first working component coupled to the body assembly and configured to move relative to the storage body;
a second working component coupled to the body assembly and configured to move relative to the storage body;
an energy storage device coupled to at least one of the chassis or the body assembly;
a first power converter configured to provide a first voltage to the first working component, the first power converter comprising a first input electrically coupled to the energy storage device; and
a second power converter configured to provide a second voltage to the second working component, the second power converter comprising a second input electrically coupled to the energy storage device.

2. The refuse vehicle of claim 1, wherein the body assembly further comprises:
a tailgate rotatably coupled to the storage body, the tailgate and the storage body together defining a refuse compartment; and
a packer disposed within the storage body, dividing the refuse compartment into a refuse storage space and a forward space, wherein the first power converter and the second power converter are disposed within the forward space.

3. The refuse vehicle of claim 1, wherein the first working component is a lift assembly, and the second working component is a packer assembly.

4. The refuse vehicle of claim 1, further comprising a third working component coupled to the body assembly and configured to move relative to the storage body, wherein the second power converter is configured to provide a third voltage to the third working component.

5. The refuse vehicle of claim 4, wherein the second voltage is greater than the third voltage.

6. The refuse vehicle of claim 4, wherein the third working component is one of a tailgate assembly, a top door assembly, or a thermal management system.

7. The refuse vehicle of claim 1, wherein the first working component comprises a plurality of electric actuators, and wherein the first power converter further comprises a plurality of outputs, wherein each of the plurality of outputs is electrically coupled with one of the plurality of electric actuators.

8. A refuse storage body, comprising:
a body assembly defining a refuse compartment;
a first working component coupled with the body assembly and configured to move relative to the body assembly;
a second working component coupled with the body assembly and configured to move relative to the body assembly;
a first power converter configured to provide a first voltage to the first working component, the first power converter comprising a first input configured to be electrically coupled to an energy storage device; and
a second power converter configured to provide a second voltage to the second working component, the second power converter comprising a second input configured to be electrically coupled to the energy storage device.

9. The refuse storage body of claim 8, further comprising a packer disposed within the body assembly, the packer dividing the refuse compartment into a refuse storage space and a forward space, wherein the first power converter and the second power converter are disposed within the forward space.

10. The refuse storage body of claim 8, further comprising a third working component coupled to the body assembly and configured to move relative to the body assembly, wherein the second power converter is configured to provide a third voltage to the third working component.

11. The refuse storage body of claim 10, wherein the first working component is a lift assembly, the second working component is a packer, and the third working component is one of a tailgate assembly, a top door assembly, or a thermal management system.

12. The refuse storage body of claim 10, wherein the second voltage is greater than the third voltage.

13. The refuse storage body of claim 10, wherein the second voltage is an alternating current voltage, and the third voltage is a direct current voltage.

14. A system comprising:
a first power converter configured to provide a first voltage to a first working component of a refuse vehicle that is configured to move relative to a refuse storage body of the refuse vehicle, the first power converter comprising a first input configured to be electrically coupled to an energy storage device; and
a second power converter configured to provide a second voltage to a second working component of the refuse vehicle that is configured to move relative to the refuse storage body, the second power converter comprising a second input that is configured to be electrically coupled to the energy storage device.

15. The system of claim 14, wherein the second power converter is configured to provide a third voltage to a third working component configured to move relative to the refuse storage body;
wherein the second voltage is greater than the third voltage.

16. The system of claim 15, wherein the second voltage is an alternating current voltage and the second voltage is direct current voltage.

17. The system of claim 15, further comprising a disconnect device configured to selectively electrically decouple the first input and the second input from the energy storage device.

18. The system of claim 15, further comprising a power distribution unit configured to electrically couple the first input and the second input with the energy storage device.

19. The system of claim 15, further comprising a thermal management system configured to liquid cool the first power converter and the second power converter.

20. The system of claim 14, further comprising a support structure configured to removably couple the first power converter and the second power converter with a refuse storage body.
